(19) United States
(12) Patent Application Publication
(10) Pub. No.: US 2024/0404460 A1
(43) Pub. Date: Dec. 5, 2024

(54) PIXEL COMPENSATION METHOD AND SYSTEM

(71) Applicant: SHENZHEN CHINA STAR OPTOELECTRONICS SEMICONDUCTOR DISPLAY TECHNOLOGY CO., LTD., Shenzhen (CN)

(72) Inventors: Mingyao CHEN, Shenzhen (CN); Jinao CHEN, Shenzhen (CN)

(21) Appl. No.: 17/768,231

(22) PCT Filed: Mar. 1, 2022
(86) PCT No.: PCT/CN2022/078649

§ 371 Date: Apr. 12, 2022

(30) Foreign Application Priority Data
Feb. 24, 2022 (CN) 202210170651.X

(51) Int. Cl. G09G 3/3208

(52) U.S. Cl. CPC G09G 3/3208; G09G 2320/0233; G09G 2320/0257; G09G 2320/0271

(57) ABSTRACT

The present application provides a pixel compensation method and system, including: acquiring target grayscale data; sensing brightness of the pixel unit when emitting light with the target grayscale data to acquire actual sensing data; determining sensing error data of the pixel unit according to actual sensing data and theoretical sensing data corresponding to the target grayscale data; and compensating the target grayscale data of the pixel unit based on the sensing error data. In this application, fast real-time compensation of the pixel unit is realized, and a display unevenness problem is reduced.

### BACKGROUND OF DISCLOSURE

### Field of Disclosure

The present disclosure relates to the field of display technology, in particular to a pixel compensation method and system.

### Description of Prior Art

As a current-type light-emitting device, an electroluminescent component has been increasingly applied to a display panel. An electroluminescent display panel has a self-emitting characteristic, does not require a backlight, and has advantages such as high contrast, a thin thickness, wide viewing angles, a fast reaction speed, flexibility, simple structures, and a simple manufacturing process. Therefore, the electroluminescent display panel gradually becomes a next-generation mainstream display panel. In general, a pixel circuit comprises a display unit, a thin film transistor (TFT), and a storage capacitance. The pixel circuit charges a voltage corresponding to display data to a capacitor through a fixed scan waveform switch TFT, and controls the display unit by a magnitude of the voltage, thereby adjusting light-emitting brightness of the display unit.

Process stability of the TFT has always been an important subject of a display screen and a major factor affecting a display image. Threshold voltages (Vth) and mobility of driving TFTs between a plurality of pixels are different in characteristics, the brightness deviates, brightness uniformity of the display screen decreases, and even spots or patterns of regions occur. On another hand, organic materials will age gradually with use time, and cannot be recovered, and will age faster in an area where it is lit for a long time, resulting in a residual image of an image screen. Current external compensation techniques can compensate for instability of TFTs, including cut-off voltages, mobility, etc., which are often applied to medium- and large-scale displays. In general, electrical compensation can determine data to be compensated through voltage or current acquired through a sensing signal line, thereby realizing characteristics of a compensation TFT. Uniformity of a panel can be compensated by optical compensation, and since the compensation and correction are performed by an optical method, problems caused by various reasons, such as mura generated by a process equipment, can be effectively compensated.

Although initial compensation optimization can be performed for external compensation, as the use time increases, an organic light emitting diode (OLED) also begins to deteriorate. Therefore, according to a current compensation method, the OLED cannot be effectively compensated. Therefore, a common image residual problem occurs, and use feeling is severely affected.

### SUMMARY OF DISCLOSURE

The present disclosure provides a pixel compensation method and system that can effectively improve panel uniformity, avoid image abnormalities caused by device aging, and reduce display unevenness and afterimage problems.

In a first aspect, the present disclosure provides a pixel compensation method, wherein the pixel compensation method is applied to a display device, the display device includes a plurality of pixel units, the pixel units are provided with a sensing unit for sensing brightness of the pixel units, and the method comprises:
acquiring target grayscale data;
sensing brightness of the pixel unit when emitting light with the target grayscale data to acquire actual sensing data;
determining sensing error data of the pixel unit from actual sensing data and theoretical sensing data corresponding to the target grayscale data; and
   compensating the target grayscale data of the pixel unit based on the sensing error data.

In a possible implementation of the present disclosure, before the determining the sensing error data of the pixel unit according to the actual sensing data and the theoretical sensing data corresponding to the target grayscale data, the method comprises:
analyzing the target grayscale data by a pre-constructed sensing parameter model to determine the theoretical sensing data when the pixel unit emits light with the target grayscale data.

In a possible implementation of the present disclosure, the method further comprises:
acquiring initial grayscale data;
sensing brightness at which the pixel unit emits light with the initial grayscale data to acquire initial sensing data;
acquiring an initial state parameter corresponding to the initial sensing data, the initial state parameter including an initial light-emitting duration of the pixel unit and an initial specification parameter of an integral capacitance in a sensing unit when the pixel unit emits light with the initial grayscale data; and
constructing the sensing parameter model based on the initial grayscale data, the initial sensing data, and the initial state parameter.

In a possible implementation of the present disclosure, the constructing the sensing parameter model based on the initial grayscale data, the initial sensing data, and the initial state parameter comprises:
determining whether the initial sensing data is within a preset sensing threshold range to acquire a sensing data determination result;
when a sensing data judgment result is that the initial sensing data is within the sensing threshold range, using the initial grayscale data, the initial sensing data, and the initial state parameter as a first model parameter of the sensing parameter model;
adjusting the initial state parameter to acquire a target state parameter when the sensing data judgment result is that the initial sensing data is not within the sensing threshold range;
when the target sensing data corresponding to the target state parameter is within the sensing threshold range, using the initial grayscale data, the target state parameter, and the target sensing data as a second model parameter of the sensing parameter model; and
constructing the sensing parameter model based on the first model parameter and/or the second model parameter.

In a possible implementation of the present disclosure, the constructing the sensing parameter model based on the initial grayscale data, the initial sensing data, and the initial sensing parameter comprises:
when the display device is in a black screen state, acquiring sensing data of the sensing unit in a state in which no light is sensed to acquire reference sensing data;
subtracting the initial sensing data from the reference sensing data to acquire an initial sensing difference when the sensing data judgment result is that the initial sensing data is within the sensing threshold range; and
updating the first model parameter of the sensing parameter model based on the initial sensing difference corresponding to the initial sensing data, the initial grayscale data, and the initial state parameter.

In a possible implementation of the present disclosure, the constructing the sensing parameter model based on the initial grayscale data, the initial sensing data, and the initial sensing parameter comprises:
when the target sensing data corresponding to the target state parameter is within the sensing threshold range, subtracting the target sensing data from the reference sensing parameter to acquire a target initial sensing difference; and
updating the second model parameter of the sensing parameter model based on the target initial sensing difference corresponding to the target sensing data, the initial grayscale data, and the target state parameter.

In a possible implementation of the present disclosure, the adjusting the initial state parameter to acquire the target state parameter comprises:
adjusting an initial emission duration in the initial state parameter to acquire a target initial emission duration;
adjusting the initial specification parameter of the integral capacitance in the initial state parameter to acquire a target initial specification parameter of the integral capacitance when the initial emission duration is adjusted to a preset duration range upper limit; and
the target initial emission duration and/or the target initial specification parameter of the integral capacitance are collectively used as the target state parameter.

In a possible implementation of the present disclosure, after adjusting the initial specification parameter of the integral capacitance in the initial state parameter to acquire the target initial specification parameter of the integral capacitance, the method comprises:
acquiring the sensing data of the sensing unit in a non-sensing light state and updating the reference sensing data when the display device is in the black screen state again based on the target initial specification parameter of the integral capacitance.

In a possible implementation of the present disclosure, the target grayscale data comprises first target grayscale data, the display device comprises N rows of pixel unit rows, N is a natural number, and the acquiring target grayscale data comprises:
acquiring first target grayscale data of each pixel unit in an n-th row of pixel units of the display device, wherein n is a natural number less than or equal to N.

In a possible implementation of the present disclosure, the actual sensing data comprises first actual sensing data, and the sensing the brightness of pixel unit when emitting light with the target grayscale data, comprising:
modifying an initial specification parameter of the sensing unit to acquire a first initial specification parameter corresponding to the first target grayscale data, the sensing unit sensing the pixel unit with the first initial specification parameter;
sensing the brightness when the pixel unit emits light with the first target grayscale data to acquire the first actual sensing data.

In a possible implementation of the present disclosure, the sensing error data comprises first sensing error data, and the determining the sensing error data of the pixel unit according to the actual sensing data and the theoretical sensing data corresponding to the target grayscale data comprises:
determining the first sensing error data of the pixel unit from the first actual sensing data and first theoretical sensing data corresponding to the first target grayscale data.

In a possible implementation of the present disclosure, the compensating target grayscale data of the pixel unit according to the sensing error data comprises:
compensating the first target grayscale data of the pixel unit based on the first sensing error data.

In a possible implementation of the present disclosure, the target grayscale data comprises second target grayscale data, and the acquiring target grayscale data comprises:
acquiring second target grayscale data previously saved by the display device at a reset scan point stage of the display device.

In a possible implementation of the present disclosure, the actual sensing data comprises second actual sensed data, and the sensing the brightness of the pixel unit when emitting light with the target grayscale data to acquire the actual sensing data, comprising:
modifying an initial specification parameter of the sensing unit to acquire the second initial specification parameter of the second target grayscale data, the sensing unit sensing the pixel unit with the second initial specification parameter;
sensing the brightness when the pixel unit emits light with the second target grayscale data to acquire the second actual sensing data.

In a possible implementation of the present disclosure, the sensing error data comprises second sensing error data, and the determining sensing error data of the pixel unit according to the actual sensing data and the theoretical sensing data corresponding to the target grayscale data comprises:
determining the second sensing error data of the pixel unit from the second actual sensing data and second theoretical sensing data corresponding to the second target grayscale data.

In a possible implementation of the present disclosure, the compensating target grayscale data of the pixel unit according to the sensing error data comprises:
compensating the second target grayscale data of the pixel unit based on the second sensing error data.

In a possible implementation of the present disclosure, the compensating target grayscale data of the pixel unit according to the sensing error data comprises:
determining whether the sensing error data exceeds a preset error threshold range, and acquiring a determination result; and
compensating the target grayscale data of the pixel unit based on the determination result.

In a possible implementation of the present disclosure, the determining the sensing error data of the pixel unit based on the actual sensing data and the theoretical sensing data corresponding to the target grayscale data comprises:
determining the sensing error data based on the following operational pattern:

$$ΔSense = RealSense \times Gain - TargetSense ,$$

wherein RealSense is the actual sensing data, TargetSense is the target sensing data, ΔSense is the sensing error data, and Gain is a screen display gain value.

In a possible implementation of the present disclosure, the compensating target grayscale data of the pixel unit according to the sensing error data comprises:
compensating the target grayscale data of the pixel unit based on:

$${GL}^{″} = {GL}^{′} \pm Step , Step > 0 ,$$

Wherein GL′ is the target grayscale data of the pixel unit before compensation, GL″ is the target grayscale data of the pixel unit after compensation, and Step is the pixel compensation value for compensating the target grayscale data.

In another aspect, the present disclosure provides a pixel compensation system, wherein the pixel compensation system comprises:
an acquiring module for acquiring target grayscale data;
a sensing module that senses brightness when the pixel unit emits light with the target grayscale data to acquire actual sensing data;
a determining module for determining sensing error data of the pixel unit based on actual sensing data and theoretical sensing data corresponding to the target grayscale data; and
a compensation module for compensating target grayscale data of the pixel unit based on the sensing error data.

The pixel compensation system further includes a model invocation module. The model invocation module is specifically for:
determining theoretical sensing data when the pixel unit emits light with the target grayscale data by analyzing the target grayscale data by a pre-constructed sensing parameter model.

The pixel compensation system further includes a model building module, specifically for:
acquiring initial grayscale data;
sensing brightness when the pixel unit emits light with the initial grayscale data to acquire initial sensing data;
acquiring an initial state parameter corresponding to the initial sensing data, the initial state parameter including an initial light-emitting duration of the pixel unit and an initial specification parameter of an integral capacitance in the sensing unit when the pixel unit emits light with the initial grayscale data;
constructing a sensing parameter model based on the initial grayscale data, the initial sensing data, and the initial state parameter.

The model building module is specifically for:
determining whether the initial sensing data is within a preset sensing threshold range to acquire a sensing data determination result;
using the initial grayscale data, the initial sensing data, and the initial state parameter as a first model parameter of the sensing parameter model when the sensing data judgment result is that the initial sensing data is within the sensing threshold range;
when the sensing data judgment result is that the initial sensing data is not within the sensed threshold range, adjusting the initial state parameter to acquire the target state parameter;
using the initial grayscale data, the target state parameter, and the target sensing data as a second model parameter of the sensing parameter model when the target sensing data corresponding to the target state parameter is within the sensing threshold range;
constructing a sensing parameter model based on the first model parameter and/or the second model parameter.

The model building module is specifically for:
acquiring the sensing data of the sensing unit in the non-sensing light emitting state when the display device is in the black screen state, and acquire the reference sensing data;
subtracting the initial sensing data from the reference sensing data to acquire an initial sensing difference when the sensing data judgment result is that the initial sensing data is within the sensing threshold range;
updating the first model parameter of the sensing parameter model based on the initial sensing difference corresponding to the initial sensing data, the initial grayscale data, and the initial state parameter.

The model building module is specifically for:
constructing a sensing parameter model based on initial grayscale data, initial sensing data, and initial sensing parameters, comprising:
when the target sensing data corresponding to the target state parameter is within a sensing threshold range, subtracting the target sensing data from the reference sensing parameter to acquire a target initial sensing difference;
updating the second model parameter of the sensing parameter model based on the target initial sensing difference corresponding to the target sensing data, the initial grayscale data, and the target state parameter.

The model building module is specifically for:
adjusting the initial emission duration in the initial state parameter to acquire the target initial emission duration;
adjusting an initial specification parameter of an integral capacitance in the initial state parameter to acquire a target initial specification parameter of the integral capacitance when the initial emission duration is adjusted to a preset duration range upper limit;
using the target initial light emission duration and/or the target initial specification parameter of the integration capacitance collectively as the target state parameter.

The model building module is specifically for;
after adjusting the initial specification parameter of the integral capacitance in the initial state parameter to acquire the target initial specification parameter of the integral capacitance, the method comprises:
acquiring the sensing data of the sensing unit in the non-sensing light state when the display device is in the black screen state again based on the target initial specification parameter of the integral capacitance, and updating the reference sensing data.

The target grayscale data includes first target grayscale data, the display device includes N rows of pixel unit rows, N is a natural number, and the acquiring module 501 is specifically for:
acquiring first target grayscale data for each pixel cell in the row of pixel cells of the first row of display device, n being a natural number less than or equal to N.

The target grayscale data includes second target grayscale data, and the acquiring module is specifically for:
determining whether the sensing error data exceeds a preset error threshold range, and acquiring a determination result;
compensating the target grayscale data of the pixel unit according to the determination result.

In the present disclosure, the theoretical sensing data theoretically possessed by the target grayscale data is determined according to the target grayscale data during the process that the pixel unit emits light with the target grayscale data, and the brightness of the pixel unit is sensed in real time by the sensing unit, the actual sensing data is acquired, the actual sensing data is compared with the theoretical sensing data, and the pixel unit is compensated according to the sensing error data acquired by comparison, and thus rapid real-time compensation for the pixel unit is achieved and display unevenness and afterimage problems are reduced.

### DESCRIPTION OF DRAWINGS

In order to more clearly illustrate technical solutions in the embodiments of the present disclosure, the accompanying drawings required for use in the description of the embodiments will be briefly described below. It will be apparent that the accompanying drawings in the following description are merely some embodiments of the present disclosure, and other drawings may be acquired from these drawings without creative effort by those skilled in the art.

FIG. 1 is a schematic structural diagram of a photosensitive sensing circuit provided in the prior art of the present disclosure.

FIG. 2 is a schematic structural diagram of a pixel compensation structure provided in the prior art of the present disclosure.

FIG. 3 is a schematic structural diagram of a pixel compensation structure provided in the prior art of the present disclosure.

FIG. 4 is a flowchart of an embodiment of a pixel compensation method provided in an embodiment of the present disclosure.

FIG. 5 is a flowchart of an embodiment of a pixel compensation method provided in an embodiment of the present disclosure.

FIG. 6 is a flowchart of an embodiment of a pixel compensation method provided in an embodiment of the present disclosure.

FIG. 7 is a flowchart of an embodiment of a pixel compensation method provided in an embodiment of the present disclosure.

FIG. 8 is a flowchart of an embodiment of a pixel compensation method provided in an embodiment of the present disclosure.

FIG. 9 is a flowchart of an embodiment of a pixel compensation method provided in an embodiment of the present disclosure.

FIG. 10 is a schematic structural diagram of an embodiment of a pixel compensation system provided in an embodiment of the present disclosure.

### DETAILED DESCRIPTION OF EMBODIMENTS

Technical solutions in embodiments of the present disclosure will be clearly and completely described below in conjunction with drawings in the embodiments of the present disclosure. Obviously, the described embodiments are only a part of embodiments of the present disclosure, rather than all the embodiments. Based on the embodiments in the present disclosure, all other embodiments acquired by those skilled in the art without creative work fall within the protection scope of the present disclosure.

In the description of the invention, it is to be understood that he term “first”, “second” are for illustrative purposes only and are not to be construed as indicating or imposing a relative importance or implicitly indicating the number of technical features indicated. Thus, a feature that limited by “first”, “second” may expressly or implicitly include at least one of the features. In the description of the present disclosure, the meaning of “plural” is two or more, unless otherwise specifically defined.

In the present disclosure, the word “exemplary” is used to mean “serving as an example, illustration, or explanation”. Any embodiment described as “exemplary” in the present disclosure is not necessarily construed as being more preferable or advantageous than other embodiments. In order to enable any person skilled in the art to implement and use the present disclosure, the following description is given. In the following description, the details are listed for the purpose of explanation. It should be understood that those of ordinary skill in the art can realize that the present disclosure can also be implemented without using these specific details. In other instances, well-known structures and processes will not be elaborated to avoid unnecessary details to obscure the description of the present disclosure. Therefore, the present disclosure is not intended to be limited to the illustrated embodiments, but is consistent with the widest scope that conforms to the principles and features disclosed in the present disclosure.

As shown in FIG. 1, it is a photosensitive sensing circuit according to the prior art, wherein Sense_sw refers to a sensing switch, REF_TFT refers to a reference voltage of a TFT, INTRST refers to a reset switch, Cf refers to a high-frequency capacitor, cF refers to a motherboard chip capacitor, FA refers to a isolation switch, LPF refers to a low-pass filter, CDS1A˜CDS2A and CDS1B˜CDS2B refer to control switches, MUX refers to a data selector or a current integrator, and ADC refers to a digital-to-analog converter. In an application process, when a photosensitive sensing member Sensor senses light, a corresponding current is generated through photoelectric conversion, and finally the current can be read by the current integrator MUX, and a current illumination amount is converted.

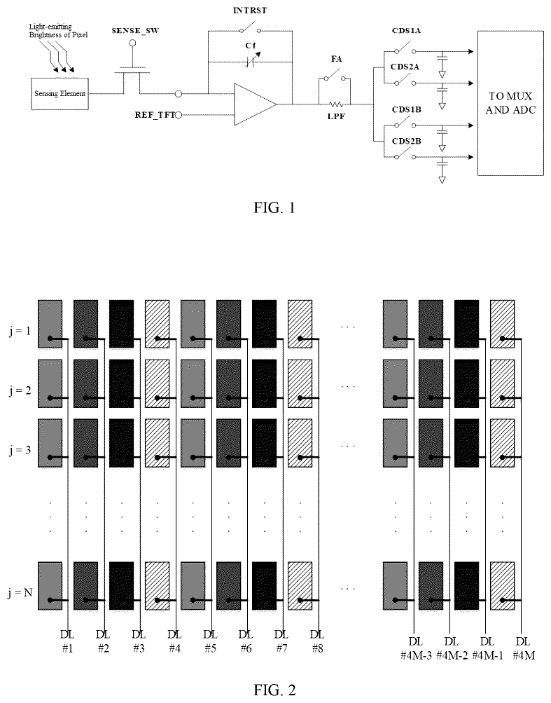

A large-size OLED is used as an example. As shown in FIG. 2, a four-color pixel unit arrangement mode proposed in the prior art is shown. The four-color pixel unit refers to adding another sub-pixel on a basis of a traditional three-color pixel unit, that is, four-color sub-pixels. At present, most of them are adding white on a basis of red, green, and blue, and yellow can also be added. FIG. 2 shows four types of pixels RGBW, where j refers to a number of columns of pixel units, and DL refers to a data line connected by pixels in the pixel unit.

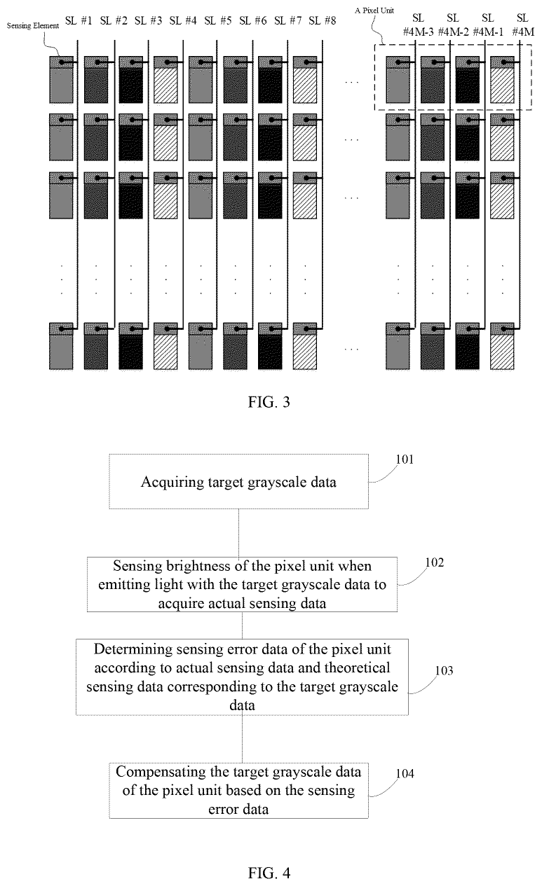

A pixel unit structure acquired by combining the above-described photosensitive sensing circuit with the four-color pixel unit may be a structure as shown in FIG. 3, wherein each sub-pixel of the pixel unit is provided with a photosensitive sensing member, the photosensitive sensing member may be disposed above or around the sub-pixel, and a plurality of sub-pixels of a same color in a same longitudinal direction share a same sensing line, where j refers to the number of columns of the pixel units, and SL refers to a sensing line connected by pixels in the pixel unit. An amount of light of each sub-pixel is sensed by the photosensitive sensing member, and compensation data of the corresponding sub-pixel is acquired through a specific algorithm. The compensation data may be pixel values of the sub-pixel, and external compensation of the pixel unit is realized.

Although the external compensation described above can perform initial compensation optimization of the pixel unit, an OLED device also starts to age as the use time increases, and the OLED cannot be effectively compensated according to the external compensation method described above. Therefore, a common image residual problem occurs, and the use feeling is severely affected.

In order to solve the above problems, embodiments of the present disclosure provide a pixel compensation method and system, which are applied to a display device, the display device comprises a plurality of pixel units, the pixel units are provided with a sensing unit for sensing brightness of the pixel units. The display device may be a liquid crystal display (LCD) or an organic light emitting diode display (OLED). An arrangement mode of the pixel unit and the sensing unit may be as shown in FIG. 3, or may be another arrangement mode. The sensing unit comprises the photosensitive sensing member and the photosensitive sensing circuit disclosed above, the brightness of the pixel unit is sensed by the light-sensitive sensing member, and the sensed brightness is converted into the amount of light by the light-sensitive sensing circuit. Detailed description will be given below.

As shown in FIG. 4, it is a flowchart of an embodiment of the pixel compensation method according to the embodiments of the present disclosure. The pixel compensation method comprises following steps 101 to 104:
101. Acquiring target grayscale data.

The display device comprises a display driving module, a display panel, and an external memory. In an application process, target grayscale data of an image to be displayed in a next frame to be displayed is inputted to the display driving module through the external memory, the display driving module detects and analyzes the target grayscale data, generates a display driving voltage corresponding to the target grayscale data based on a reference voltage, and inputs the display driving voltage to the pixel unit of the display device for driving and displaying.
102. Sensing brightness of a pixel unit when emitting light according to the target grayscale data, and actual sensing data is acquired.

When a display driving voltage corresponding to the target grayscale data is applied to the pixel unit, the pixel unit emits light with the target grayscale data, and senses actual emission brightness when the pixel unit emits light by the sensing unit to acquire the actual sensing data.
103. Determining sensing error data of the pixel unit based on the actual sensing data and theoretical sensing data corresponding to the target grayscale data.

Before the sensing unit senses the actual emission brightness when the pixel unit emits light and acquires the actual sensing data, analyzing the target grayscale data by a pre-constructed sensing parameter model to determine the theoretical sensing data that the pixel unit should theoretically have when emitting light with the target grayscale data. After the actual sensing data is sensed, the actual sensing data is compared with the theoretical sensing data and analyzed, and the sensing error data is analyzed, so that it is convenient to subsequently determine whether the pixel unit needs to be compensated according to the sensing error data.
104. The target grayscale data of the pixel unit is compensated based on the sensing error data.

Specifically, the step of compensating the target grayscale data of the pixel unit according to the sensing error data includes:
Determining whether the sensing error data exceeds a preset error threshold range, and acquiring a determination result;
Compensating the target grayscale data of the pixel unit according to the determination result.

According to the sensing error data, the error value between actually displayed brightness of the pixel unit and theoretically displayed brightness is determined, that is, it is determined whether the error value exceeds the preset error threshold range: if the error value is too great and exceeds the error threshold range, the display abnormality is caused, the pixel unit is compensated for grayscale in real-time until the brightness to be theoretically displayed is acquired.

In the present disclosure, in a process in which the pixel unit emits light with the target grayscale data, the theoretical sensing data of the target grayscale data is determined according to the target grayscale data, the brightness of the pixel unit is sensed by the sensing unit in real-time to acquire the actual sensing data, the actual sensing data is compared with the theoretical sensing data, and the pixel unit is compensated according to the sensing error data acquired by the comparison, so that a fast real-time compensation of the pixel unit is realized, and the problems of uneven display and after image are reduced.

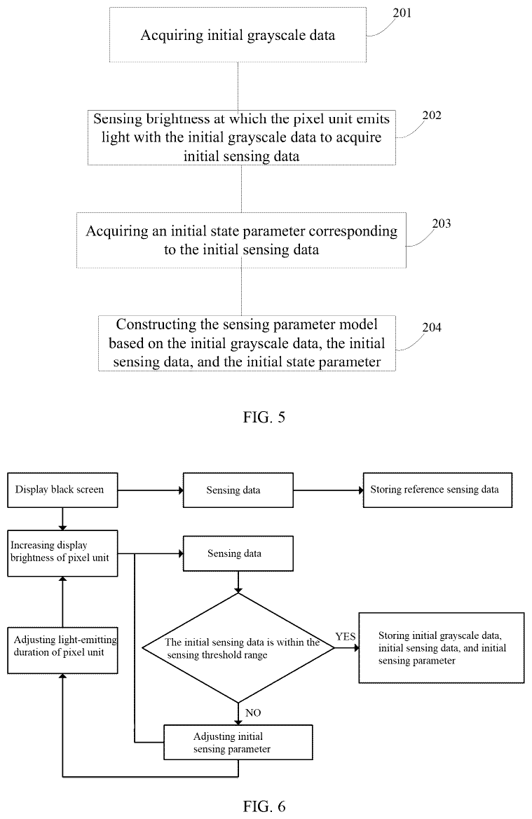

In another embodiment of the present disclosure, before the target grayscale data is analyzed by the pre-constructed sensing parameter model, the sensing parameter model needs to be pre-constructed, as shown in FIG. 5. Therefore, the method further includes following steps 201 to 204:
201. Acquiring initial grayscale data.

In constructing the sensing parameter model, the grayscale data of the image to be displayed inputted to a display driving module from the external memory is used as the initial grayscale data, and the initial grayscale data of different grayscale values is inputted in advance to the display device for display, so as to acquire theoretical brightness displayed at full grayscale for each pixel unit of the display device.
202. Sensing the brightness of the pixel unit when emitting light with the initial grayscale data to acquire the initial sensed data.

When the pixel unit emits light with the initial grayscale data, the brightness when the pixel unit emits light with the initial grayscale data is sensed by the sensing member in the display device to acquire the initial sensing data. The brightness of the pixel unit is adjusted by adjusting illumination display time of the display device, so that different light-emitting brightness is realized to acquire a plurality of brightness stages when the pixel unit emits light with initial grayscale data, and to acquire initial sensing data corresponding to the plurality of stages of brightness.
203. Acquiring an initial state parameter corresponding to the initial sensing data;

The initial state parameter includes an initial light emission duration of the pixel unit and an initial specification parameter of an integral capacitance in the sensing unit when the pixel unit emits light with the initial grayscale data, when the pixel unit emits light with the initial grayscale data, the emission duration when the pixel unit emits light with the initial grayscale data and the initial specification parameter of the integration capacitance when the sensing unit senses the light-emitting brightness of the pixel unit are saved.
204. Constructing a sensing parameter model based on the initial grayscale data, the initial sensing data, and the initial state parameter.

After acquiring the initial sensing data when the pixel unit emits light with the initial grayscale data, the initial sensing data and the initial state parameter corresponding to the initial grayscale data are stored, and the sensing parameter model is constructed based on the initial grayscale data and corresponding initial sensing data and the initial state parameter. In a practical application process, in order to save time of brightness sensing of the pixel unit, initial grayscale data of a part of grayscale values is selected as a representative, and other grayscales of the full grayscale may be constructed by linear fitting or image fitting.

Specifically, in this embodiment, constructing of the sensing parameter model based on the initial grayscale data, the initial sensing data, and the initial state parameter specifically includes:
Determining whether the initial sensing data is within a preset sensing threshold range to acquire a sensing data determination result, the sensing data determination result comprises initial sensing data being within the sensing threshold range and initial sensing data not being within the sensing threshold range.

When the sensing data determination result is that the initial sensing data is within the sensing threshold range, the initial grayscale data, the initial sensed data, and the initial state parameter are used as the first model parameter of the sensing parameter model;
Adjusting the initial state parameter to acquire the target state parameter when the determination result of the sensing data is that the initial sensing data is not within the sensing threshold range, and using the initial grayscale data, the target state parameter, and the target sensing data as second model parameter of the sensing parameter model when the target sensing data corresponding to the target state parameter is within the sensing threshold range;
Constructing the sensing parameter model based on the first model parameter and/or the second model parameter.

That is, in this embodiment, as shown in FIG. 6, a maximum threshold value and a minimum threshold value of the sensing threshold range are set in advance according to actual needs, and when the pixel unit displays with the initial grayscale data, the initial sensing data sensed by the sensing unit is determined to determine whether the initial sensing data is within the preset sensing threshold range;
Specifically, when a value of the initial sensing data is between the maximum threshold value and the minimum threshold value, it indicates that the initial sensing data currently sensed by the pixel unit is normal data, and the initial sensing data conform to a normal standard and the corresponding initial grayscale data and the initial state parameter are stored as the first model parameter of the sensing parameter model;
When the value of the initial sensing data is not between the maximum threshold value and the minimum threshold value, it indicates that the initial sensing data currently sensed by the pixel unit is abnormal data. In this case, it is necessary to adjust the initial state parameter of the pixel unit to correct the light-emitting brightness of the pixel unit, so that the initial sensing data sensed is within the sensing threshold range.

In this embodiment, the adjusting the initial state parameter to acquire the target state parameter includes:
Adjusting the initial emission duration in the initial state parameter to acquire the target initial light emission duration;
Adjusting the initial specification parameter of the integral capacitance in the initial state parameter to acquire a target initial specification parameter of the integral capacitance when the initial emission duration is adjusted to an upper limit of the preset duration range;
The target initial specification parameter of the target initial light emission duration and/or the integral capacitance are collectively used as the target state parameter.

Generally, the reason why the initial sensing data is abnormal data includes that a current light emission duration of the pixel unit is abnormal, or the initial specification parameter of the integral capacitance in the sensing unit does not meet the requirement. Therefore, by adjusting the light emission duration when the pixel unit emits light with the initial grayscale data, or adjusting the initial specification parameter of the integral capacitance in the sensing unit, the initial sensing data can be adjusted to be sensing data meeting the requirement. In an actual application, the initial specification parameter of the integral capacitance in the sensing unit is adjusted only when the light emission duration of the pixel unit emitting light with the initial grayscale data is adjusted first, and if the initial sensing data is still not within the threshold range after the light emission duration is adjusted.

After the initial sensing data is adjusted to be within the sensing threshold range, a last adjusted initial state parameter is used as the target state parameter, last acquired initial sensing data is used as the target sensing data, and the target sensing data meeting the normal standard and the corresponding initial grayscale data and the target state parameter are used as the second model parameter of the sensing parameter model.

TABLE 1
Sensing Parameter Model Table

| | 1st initial | 2nd initial | | nth initial |
|---|---|---|---|---|
| | state | state | | state |
| | parameter | parameter | . . . | parameter |
| 1st initial | 1st initial | 2nd initial | . . . | nth initial |
| sensing | grayscale | grayscale | | grayscale |
| parameter | parameter | parameter | | parameter |
| 2nd initial | (n + 1)th initial | (n + 2)th initial | . . . | (2n)th initial |
| sensing | grayscale | grayscale | | grayscale |
| parameter | parameter | parameter | | parameter |
| . . . | . . . | . . . | . . . | . . . |
| mth initial | (n(m − 1) + | (n(m − 1) + | . . . | (mn)th |
| sensing | 1)th initial | 2)th initial | | initial |
| parameter | grayscale | grayscale | | grayscale |
| | parameter | parameter | | parameter |

The sensing parameter model is then constructed based on the first model parameter and/or the second model parameter. In this embodiment, the sensing parameter model is actually a multi-dimensional model table or algorithm. Exemplarily, the multi-dimensional model table may be shown in Table 1. Elements in the multi-dimensional model table include three parameters of the first model parameter, initial sensing data, and initial grayscale data and initial state parameter corresponding thereto. Each initial sensing data corresponds to an initial grayscale data and an initial state data. Subsequently, after the initial grayscale data is inputted to the pixel unit, initial sensing data and initial state data corresponding to the initial grayscale data may be acquired by means of a sensing parameter model index.

When there is data adjustment in the sensing parameter model, elements in the sensing parameter model may include three parameters of the first model parameter and three parameters of the second model parameter at a same time. In fact, the target sensing data in the second model parameter acquired after adjustment and the initial grayscale data and the target state parameter corresponding to the target sensed data are slightly different from the initial sensing data in the first model parameter and the initial grayscale data and the initial state parameter corresponding to the target sensed data. Therefore, in the application process, data having a smaller difference between the second model parameter and the first model parameter may be fused. Therefore, the cases including the first model parameter and the second model parameter are not additionally listed here. Subsequently, after the initial grayscale data is inputted to the pixel unit, the initial sensing data and the initial state data corresponding to the initial grayscale data may be acquired by the sensing parameter model index, or the target sensing data and the target initial state data corresponding to the initial grayscale data may be acquired after the initial grayscale data is inputted to the pixel unit, thereby realizing the application of the sensing parameter model.

Since the TFT component, the sensing, the current integrator, and the like in the display panel may cause brightness sensing errors, the brightness sensing errors may be corrected by sensing a black screen, that is, when the display device does not display an image, reference sensing data of the sensing unit that does not perform brightness sensing on the display device is acquired in advance, and the actual sensing data acquired by subsequent sensing is calibrated by the reference sensing data, and the actual sensing data may include the initial sensing data and the adjusted target sensing data.

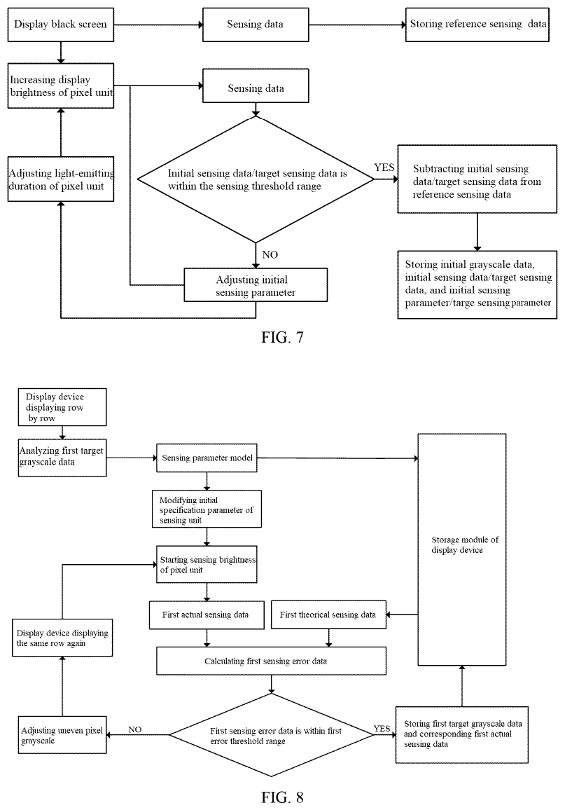

Therefore, in another embodiment of the present disclosure, as shown in FIG. 7, correcting the initial sensing data having no abnormality, specifically, constructing a sensing parameter model based on the initial grayscale data, the initial sensing data, and the initial sensing parameters, including:
When the display device is in the black screen state, acquiring the sensing data of the sensing unit in a state that light is not sensed to acquire the reference sensing data;
Subtracting the initial sensing data from the reference sensing data to acquire an initial sensing difference when the sensing data judgment result is that the initial sensing data is within the sensing threshold range;
Updating the first model parameter of the sensing parameter model based on the initial sensing difference corresponding to the initial sensing data, the initial grayscale data, and the initial state parameter.

When the display device is in a light emitting state, after the current initial sensing data of the display device is acquired, the initial sensing data is corrected by the reference sensing data, and the initial sensing data is subtracted from the reference sensing data to acquire the initial sensing difference, the initial sensing difference is the sensing data actually corresponding to the initial grayscale data. In this embodiment, the acquired initial sensing difference is used as the initial sensing data in the first model parameter to achieve the purpose of optimizing the initial sensing data in the sensing parameter model, so that the initial sensing data in the sensing parameter model is more accurate. At a same time, after each initial sensing data is subtracted from the reference sensing data, overall data of the first model parameter is compressed, so that a data amount of the first model parameter is reduced, and a operation load of the display drive module in the display device is reduced.

In another embodiment of the present disclosure, as shown in FIG. 7, abnormal and adjusted target sensing data is corrected, and specifically, constructing the sensing parameter model based on initial grayscale data, initial sensing data, and initial sensing parameter comprises:
When the target sensing data corresponding to the target state parameter is within a sensing threshold range, subtracting the target sensing data from the reference sensing parameter to acquire a target initial sensing difference;
Updating the second model parameter of the sensing parameter model based on the target initial sensing difference corresponding to the target sensing data, the initial grayscale data, and the target state parameter.

After the target sensing data is adjusted to be within the sensing threshold range, the target sensing data is corrected by the reference sensing data to achieve a purpose of optimizing the target sensing data in the sensing parameter model and to make the target sensing data in the sensing parameter model more accurate.

In this embodiment, after the initial specification parameter of the integral capacitance in the sensing unit is adjusted, a specification of the sensing unit changes at this time, and the brightness sensing using the updated sensing unit causes a deviation between the brightness data sensed by the updated sensing unit and that sensed by the sensing unit that has not been updated previously. Therefore, the reference sensing data of the sensing unit needs to be updated again.

That is, in another embodiment of the present disclosure, after adjusting the initial specification parameter of the integral capacitance in the initial state parameter to acquire the target initial specification parameter of the integral capacitance, the method includes:
Based on the target initial specification parameter of the integral capacitance, when the display device is again in the black screen state, the sensing data of the sensing unit in a state that light is not sensed is acquired, and the reference sensing data is updated.

After integrating the initial specification parameter of the capacitance in the sensing unit, the data of the display device in the undisplayed state is sensed again, and the reference sensing data corresponding to the updated initial specification parameter of the integral capacitance is updated. Subsequently, by subtracting the initial sensing data sensed from the updated reference sensing data, the error in the subsequently sensed initial sensing data caused by adjusting the initial specification parameter of the integrated capacitance in the sensing unit can be reduced.

In the present disclosure, the pixel compensation method of the display device includes a timing compensation method and a real-time compensation method. Specifically, the timing compensation method refers to sequentially compensating the pixel units of the display device when the display device is in a non-real-time display state, and the real-time compensation method refers to dynamically compensating the pixel units of the display device when the display device is in a real-time display state. The foregoing two compensation modes are described in detail below.

In another embodiment of the present disclosure, when pixel compensation is performed on a pixel unit of a display device using the timing compensation method, target grayscale data includes a first target grayscale data, the display device includes N rows of pixel unit rows, N is a natural number, and the acquiring target grayscale data includes:
Acquiring first target grayscale data of each pixel unit in an nth row of the pixel unit of display device, n being a natural number less than or equal to N.

In this embodiment, when the display device is in an initial state of the power-on/off stage, that is, when the display device is not illuminated, the display device is in a black screen state, and the sensing unit is in an initial state in which no light is sensed, as shown in FIG. 8, at this time, if n=1, the first target grayscale data of each pixel unit in the first row of pixel units of the display device is acquired, the first row of pixel units of the display device is illuminated, the first target grayscale data is inputted to the sensing parameter model for analysis, and the first theoretical sensing parameter data corresponding to the first target grayscale data is acquired.

Therefore, in this embodiment, the acquiring the actual sensing data by sensing the brightness when the pixel unit emits light with the target grayscale data includes:
Modifying the initial specification parameter of the sensing unit to acquire the first initial specification parameter corresponding to the first target grayscale data, and sensing the pixel unit with the first initial specification parameter;
Sensing the brightness when the pixel unit emits light with the first target grayscale data to acquire the first actual sensing data.

Determining the sensing error data of the pixel unit based on the actual sensing data and the theoretical sensing data corresponding to the target grayscale data includes: determining the first sensing error data of the pixel unit based on the first actual sensing data and the first theoretical sensing data corresponding to the first target grayscale data.

Compensating the target grayscale data of the pixel unit based on the sensing error data includes: compensating the first target grayscale data of the pixel unit based on the first sensing error data.

Specifically, it is determined whether the first sensing error data exceeds the preset first error threshold range, a first determination result is acquired, and the first target grayscale data of the pixel unit is compensated according to the first determination result.

Exemplarily, if the first actual sensing data of all the pixel units in the first row of the display device is set to be RealSense1, the first actual sensing data is set to be TargetSense1, and the first sensing error data is set to be ΔSense1, the operation mode may be set to be ΔSense1=RealSense1×Gain−TargetSense1, where Gain refers to a gain value of the screen display. In actual application, the gain value of the screen display may be set according to the actual situation, and the first sensing error data may be set to be the ΔSense1 operation mode or other modes, which is not specifically limited in this example.

If the first sensing error data ΔSense1 is within the set first error threshold range, it represents that the picture currently displayed by the pixel unit of the display device is uniform, and the current first target grayscale data and the corresponding first actual sensing data RealSense1 may be stored for subsequent display;
If the first sensing error data ΔSense1 is not within the set first error threshold range, it represents that the screen currently displayed by the pixel unit of the display device is uneven, and it is necessary to compensate the first target grayscale data that causes the display to be uneven, the first target grayscale data is set to be GL1′, the first target grayscale data after compensation is set to be GL1″, and a formula for compensating the first target grayscale data may be GL1″=GL1′±Step1, Step1>0, where Step1 is a pixel compensation value for compensating the first target grayscale data. In actual application, the pixel compensation value may be set according to the actual situation, and when the display brightness corresponding to the compensated first target grayscale data GL1′ is uniform, the first target grayscale data after compensation GL1″ and corresponding brightness data are stored for subsequent display;

When the first target grayscale data of all the pixel units in the first row of the display device is compensated, all the pixel units in the second row of the display device are illuminated, and the above steps are repeated to compensate all the pixel units in the second row until all the pixel units of the display device are compensated.

In a possible implementation of the present disclosure, when the display device is in a real-time display state and pixel compensation is performed on the pixel unit of the display device using the real-time compensation method, the target grayscale data includes second target grayscale data, and the acquiring target grayscale data includes:
In a reset scan point stage of the display device, acquiring the second target grayscale data saved by the display device at the last time.

In this embodiment, since the display device is in the real-time display state and the display screen changes all the time, the grayscale compensation for the pixel unit can be performed only at a non-driving time of the display device, that is, at a blanking time of the display device.

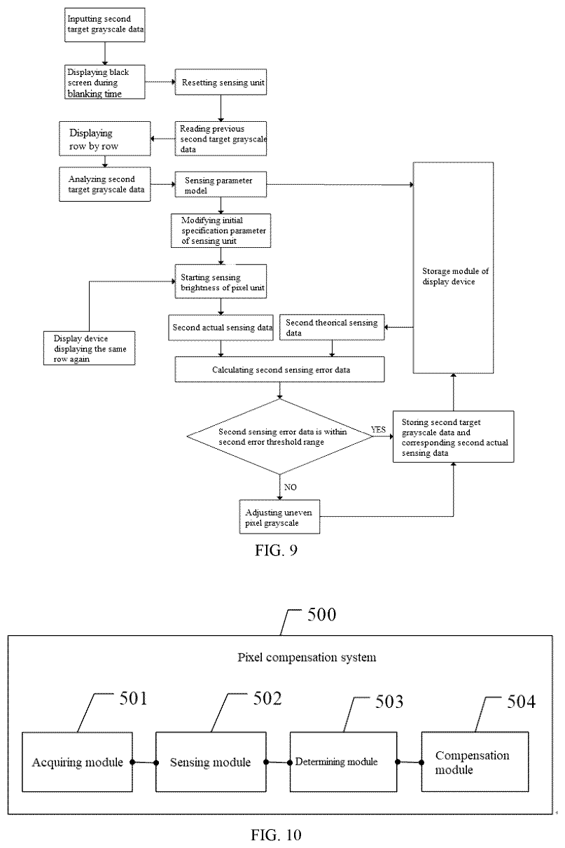

When the display device is in the blanking time, the display device is in a black screen state, and the sensing unit is in an initial state in which no light is sensed. At this time, the sensing unit is reset so that the sensing unit is in an initial state, and at a same time, the display device acquires last grayscale data stored in the display driving module, that is, the second target grayscale data, as shown in FIG. 9. At this time, the display device is controlled to display the second target grayscale data row by row, and at a same time, the second target grayscale data is inputted to the sensing parameter model for analysis, and the second theoretical sensing parameter data corresponding to the second target grayscale data is acquired.

Therefore, in this embodiment, acquiring the actual sensing data by sensing the brightness when the pixel unit emits light with the target grayscale data includes:
Modifying an initial specification parameter of the sensing unit to acquire a second initial specification parameter of the second target grayscale data, and sensing the pixel unit with the second initial specification parameter;
Acquiring the second actual sensing data by sensing the brightness when the pixel unit emits light with the second target grayscale data.

Determining the sensing error data of the pixel unit based on the actual sensing data and the theoretical sensing data corresponding to the target grayscale data includes: determining the second sensing error data of the pixel unit based on the second actual sensing data and the second theoretical sensing data corresponding to the second target grayscale data.

Compensating the target grayscale data of the pixel unit based on the sensing error data includes: compensating the second target grayscale data of the pixel unit based on the second sensing error data.

Specifically, it is determined whether the second sensing error data exceeds the preset second error threshold range, a second determination result is acquired, and the second target grayscale data of the pixel unit is compensated according to the second determination result.

Exemplarily, if the second actual sensing data of all the pixel units of the display device is set to be RealSense2, the second actual sensing data is set to be TargetSense2, and the second sensing error data is set to be ΔSense2, the operation mode may be set to be ΔSense2=RealSense2×Gain−TargetSense2, where Gain refers to the screen display gain value. In the actual application, the screen display gain value may be set according to the actual situation, and the second sensing error data may be set to be ΔSense2 operation mode or other modes, which is not specifically limited in this example.

If the second sensing error data ΔSense2 is within the set second error threshold range, it represents that the picture currently displayed by the display device pixel unit is uniform, and the current second target grayscale data and the corresponding second actual sensing data RealSense2 may be stored for subsequent display;
If the second sensing error data is that the ΔSense2 is not within the set second error threshold range, it represents that the screen currently displayed by the pixel unit of the display device is uneven, and it is necessary to compensate the second target grayscale data resulting in uneven display. The second target grayscale data is set to be GL2′, and the second target grayscale data after compensation is GL2″. The formula for compensating the second target grayscale data may be GL2″=GL2′±Step2, Step2>0, where Step2 is a pixel compensation value for compensating the second target grayscale data. In actual application, the pixel compensation value may be set according to the actual situation, and when the display brightness corresponding to the compensated second target grayscale data GL2′ is uniform, the second target grayscale data after compensation GL2″ and corresponding brightness data are stored for subsequent display;

The above steps are repeated until the second target grayscale data of all pixel units of the display device are compensated. The real-time pixel compensation of the display device in the above-described manner facilitates fast pixel compensation in the display process of the display device and enhances the uniformity of the display screen of the display device.

In order to better implement the pixel compensation method in the embodiment of the present disclosure, on a basis of the pixel compensation method, a pixel compensation system is further provided in the embodiment of the present disclosure. As shown in FIG. 10, the pixel compensation system 500 includes:
An acquiring module 501 for acquiring target grayscale data;
A sensing module 502 for sensing brightness of a pixel unit when emitting light with the target grayscale data to acquire actual sensing data;
A determining module 503 for determining sensing error data of the pixel unit according to the actual sensing data and theoretical sensing data corresponding to the target grayscale data;
A compensation module 504 for compensating the target grayscale data of the pixel unit based on the sensing error data.

The pixel compensation system further includes a model invocation module. The model invocation module is specifically for:
Determining the theoretical sensing data when the pixel unit emits light with the target grayscale data by analyzing the target grayscale data by a pre-constructed sensing parameter model.

The pixel compensation system further includes a model building module, specifically for:
Acquiring initial grayscale data;
Sensing brightness when the pixel unit emits light with the initial grayscale data to acquire initial sensing data;
Acquiring initial state parameter corresponding to the initial sensing data, the initial state parameter including an initial light emission duration of the pixel unit and an initial specification parameter of an integral capacitance in the sensing unit when the pixel unit emits light with the initial grayscale data;
Constructing a sensing parameter model based on the initial grayscale data, the initial sensing data, and the initial state parameter.

The model building module is specifically for:
Determining whether the initial sensing data is within a preset sensing threshold range to acquire a sensing data determination result;
Using the initial grayscale data, the initial sensing data, and the initial state parameter as a first model parameter of the sensing parameter model when the sensing data determination result is that the initial sensing data is within the sensing threshold range;
When the sensing data judgment result is that the initial sensing data is not within the sensed threshold range, adjusting the initial state parameter to acquire the target state parameter;
Using the initial grayscale data, the target state parameter, and the target sensing data as a second model parameter of the sensing parameter model when the target sensing data corresponding to the target state parameter is within the sensing threshold range;
Constructing a sensing parameter model based on the first model parameter and/or the second model parameter.

The model building module is specifically for:
Acquiring the sensing data of the sensing unit in a state that light is not sensed when the display device is in the black screen state, and acquiring the reference sensing data;

Subtracting the initial sensing data from the reference sensing data to acquire an initial sensing difference when the sensing data judgment result is that the initial sensing data is within the sensing threshold range;
Updating the first model parameter of the sensing parameter model based on the initial sensing difference corresponding to the initial sensing data, the initial grayscale data, and the initial state parameter.

The model building module is specifically for:
Constructing a sensing parameter model based on initial grayscale data, initial sensing data, and initial sensing parameters, comprising:
When the target sensing data corresponding to the target state parameter is within a sensing threshold range, subtracting the target sensing data from the reference sensing parameter to acquire a target initial sensing difference;
Updating the second model parameter of the sensing parameter model based on the target initial sensing difference corresponding to the target sensing data, the initial grayscale data, and the target state parameter.

The model building module is specifically for:
Adjusting the initial light emission duration in the initial state parameter to acquire the target initial light emission duration;
Adjusting an initial specification parameter of an integral capacitance in the initial state parameter to acquire a target initial specification parameter of the integral capacitance when the initial light emission duration is adjusted to an upper limit of the preset duration range;
Using the target initial light emission duration and/or the target initial specification parameter of the integration capacitance collectively as the target state parameter.

The model building module is specifically for:
After adjusting the initial specification parameter of the integral capacitance in the initial state parameter to acquire the target initial specification parameter of the integral capacitance, the method comprises:
Acquiring the sensing data of the sensing unit in a state that light is not sensed when the display device is in the black screen state again based on the target initial specification parameter of the integral capacitance, and updating the reference sensing data.

The target grayscale data includes first target grayscale data, the display device includes N rows of the pixel unit, N is a natural number, and the acquiring module 501 is specifically for:

Acquiring first target grayscale data for each pixel unit in an nth row of the pixel unit of display device, n being a natural number less than or equal to N.

The target grayscale data includes second target grayscale data, and the acquiring module is specifically for:

Determining whether the sensing error data exceeds a preset error threshold range, and acquiring a determination result;

Compensating the target grayscale data of the pixel unit according to the determination result.

The pixel compensation method and system provided in the embodiments of the present disclosure are described in detail above. The principles and embodiments of the present disclosure are described by using specific examples. The description of the embodiments is merely intended to help understand the method and core ideas of the present disclosure. At the same time, for those skilled in the art, there may be changes in the specific embodiments and application scope according to the idea of the present disclosure. In conclusion, the content of this specification should not be construed as a limitation on the present disclosure.

What is claimed is:

1. A pixel compensation method, wherein the pixel compensation method is applied to a display device, the display device includes a plurality of pixel units, the pixel units are provided with a sensing unit for sensing brightness of the pixel units, and the method comprises:
acquiring target grayscale data;
sensing brightness of the pixel unit when emitting light with the target grayscale data to acquire actual sensing data;
determining sensing error data of the pixel unit according to actual sensing data and theoretical sensing data corresponding to the target grayscale data;
compensating the target grayscale data of the pixel unit based on the sensing error data.

2. The pixel compensation method according to claim 1, wherein before the determining the sensing error data of the pixel unit according to the actual sensing data and the theoretical sensing data corresponding to the target grayscale data, the method comprises:
analyzing the target grayscale data by a pre-constructed sensing parameter model to determine the theoretical sensing data when the pixel unit emits light with the target grayscale data.

3. The pixel compensation method according to claim 2, wherein before the analyzing the target grayscale data by the pre-constructed sensing parameter model, the method further comprises:
acquiring initial grayscale data;
sensing brightness of the pixel unit when emitting light with the initial grayscale data to acquire initial sensing data;
acquiring an initial state parameter corresponding to the initial sensing data, the initial state parameter including an initial light emission duration of the pixel unit and an initial specification parameter of an integral capacitance in the sensing unit when the pixel unit emits light with the initial grayscale data;
constructing the sensing parameter model based on the initial grayscale data, the initial sensing data, and the initial state parameter.

4. The pixel compensation method according to claim 3, wherein the constructing the sensing parameter model based on the initial grayscale data, the initial sensing data, and the initial state parameter comprises:
determining whether the initial sensing data is within the sensing threshold range preset to acquire a sensing data determination result;
when the sensing data judgment result is that the initial sensing data is within the sensing threshold range, using the initial grayscale data, the initial sensing data, and the initial state parameter as a first model parameter of the sensing parameter model;
adjusting the initial state parameter to acquire a target state parameter when the sensing data judgment result is that the initial sensing data is not within the sensing threshold range;
when target sensing data corresponding to the target state parameter is within the sensing threshold range, using the initial grayscale data, the target state parameter, and the target sensing data as a second model parameter of the sensing parameter model;
constructing the sensing parameter model based on the first model parameter and/or the second model parameter.

5. The pixel compensation method according to claim 4, wherein the constructing the sensing parameter model based on the initial grayscale data, the initial sensing data, and the initial sensing parameter comprises:
when the display device is in a black screen state, acquiring sensing data of the sensing unit in a state when no light is sensed to acquire reference sensing data;
subtracting the initial sensing data from the reference sensing data to acquire an initial sensing difference when the sensing data determination result is that the initial sensing data is within the sensing threshold range;
updating the first model parameter of the sensing parameter model based on the initial sensing difference corresponding to the initial sensing data, the initial grayscale data, and the initial state parameter.

6. The pixel compensation method according to claim 5, wherein the constructing the sensing parameter model based on the initial grayscale data, the initial sensing data, and the initial sensing parameter comprises:
when the target sensing data corresponding to the target state parameter is within the sensing threshold range, subtracting the target sensing data from the reference sensing parameter to acquire a target initial sensing difference;
updating the second model parameter of the sensing parameter model based on the target initial sensing difference corresponding to the target sensing data, the initial grayscale data, and the target state parameter.

7. The pixel compensation method according to claim 5, wherein the adjusting the initial state parameter to acquire the target state parameter comprises:
adjusting an initial light emission duration in the initial state parameter to acquire a target initial light emission duration;
adjusting the initial specification parameter of the integral capacitance in the initial state parameter to acquire a target initial specification parameter of the integral capacitance when the initial light emission duration is adjusted to a preset duration range upper limit;
using the target initial emission duration and/or the target initial specification parameter of the integral capacitance collectively as the target state parameter.

8. The pixel compensation method according to claim 7, wherein after adjusting the initial specification parameter of the integral capacitance in the initial state parameter to acquire the target initial specification parameter of the integral capacitance, the method comprises:
acquiring the sensing data of the sensing unit in a state that no light is sensed and updating the reference sensing data when the display device is in the black screen state again based on the target initial specification parameter of the integral capacitance.

9. The pixel compensation method according to claim 3, wherein the target grayscale data comprises first target grayscale data, the display device comprises N rows of pixel unit rows, N is a natural number, and the acquiring target grayscale data comprises:
acquiring first target grayscale data of each pixel unit in an nth row of the pixel units of the display device, wherein n is a natural number less than or equal to N.

10. The pixel compensation method according to claim 9, wherein the actual sensing data comprises first actual sensing data, and the sensing the brightness of the pixel unit when emitting light with the target grayscale data comprises:
modifying an initial specification parameter of the sensing unit to acquire a first initial specification parameter corresponding to the first target grayscale data, the sensing unit sensing the pixel unit with the first initial specification parameter;
sensing the brightness of the pixel unit when emitting light with the first target grayscale data to acquire the first actual sensing data.

11. The pixel compensation method according to claim 10, wherein the sensing error data comprises first sensing error data, and the determining the sensing error data of the pixel unit according to the actual sensing data and the theoretical sensing data corresponding to the target grayscale data comprises:
determining the first sensing error data of the pixel unit from the first actual sensing data and first theoretical sensing data corresponding to the first target grayscale data.

12. The pixel compensation method according to claim 11, wherein the compensating the target grayscale data of the pixel unit according to the sensing error data comprises:
compensating the first target grayscale data of the pixel unit based on the first sensing error data.

13. The pixel compensation method according to claim 3, wherein the target grayscale data comprises second target grayscale data, and the acquiring the target grayscale data comprises:
acquiring second target grayscale data previously saved by the display device at a reset scan point stage of the display device.

14. The pixel compensation method according to claim 13, wherein the actual sensing data comprises second actual sensing data, and the sensing the brightness of the pixel unit when emitting light with the target grayscale data to acquire the actual sensing data, comprising:
modifying an initial specification parameter of the sensing unit to acquire a second initial specification parameter of the second target grayscale data, the sensing unit sensing the pixel unit with the second initial specification parameter;
sensing the brightness of the pixel unit when emitting light with the second target grayscale data to acquire the second actual sensing data.

15. The pixel compensation method according to claim 14, wherein the sensing error data comprises second sensing error data, and the determining the sensing error data of the pixel unit according to the actual sensing data and the theoretical sensing data corresponding to the target grayscale data comprises:
determining the second sensing error data of the pixel unit according to the second actual sensing data and second theoretical sensing data corresponding to the second target grayscale data.

16. The pixel compensation method according to claim 15, wherein the compensating the target grayscale data of the pixel unit according to the sensing error data comprises:
compensating the second target grayscale data of the pixel unit based on the second sensing error data.

17. The pixel compensation method according to claim 1, wherein the compensating the target grayscale data of the pixel unit according to the sensing error data comprises:
determining whether the sensing error data exceeds a preset error threshold range, and acquiring a determination result;
compensating the target grayscale data of the pixel unit based on the determination result.

18. The pixel compensation method according to claim 1, wherein the determining the sensing error data of the pixel unit based on the actual sensing data and the theoretical sensing data corresponding to the target grayscale data comprises:
determining the sensing error data based on a following operational mode:
$$ΔSense = RealSense \times Gain - TargetSense ,$$
wherein RealSense is the actual sensing data, TargetSense is the target sensing data, ΔSense is the sensing error data, and Gain is a screen display gain value.

19. The pixel compensation method according to claim 1, wherein the compensating the target grayscale data of the pixel unit according to the sensing error data comprises:
compensating the target grayscale data of the pixel unit based on a following operation mode:
$${GL}^{″} = {GL}^{′} \pm Step , Step > 0 ,$$
wherein GL′ is the target grayscale data of the pixel unit before compensation, GL″ is the target grayscale data of the pixel unit after compensation, and Step is a pixel compensation value for compensating the target grayscale data.

20. A pixel compensation system, wherein the pixel compensation system comprises:
an acquiring module for acquiring target grayscale data;
a sensing module that senses brightness when a pixel unit emits light with the target grayscale data to acquire actual sensing data;
a determining module for determining sensing error data of the pixel unit based on actual sensing data and theoretical sensing data corresponding to the target grayscale data;
a compensation module for compensating the target grayscale data of the pixel unit based on the sensing error data.
